(19) United States
(12) Patent Application Publication
(10) Pub. No.: US 2006/0164313 A1
(43) Pub. Date: Jul. 27, 2006

(54) Device for the reception and/or the transmission of multibeam signals

(75) Inventors: Francoise Le Bolzer, Rennes (FR); Ali Louzir, Rennes (FR)

Correspondence Address: THOMSON LICENSING INC., PATENT OPERATIONS, PO BOX 5312, PRINCETON, NJ, 08543-5312, US

(73) Assignee: THOMSON LICENSING

(21) Appl. No.: 11/299,640

(22) Filed: Dec. 12, 2005

Related U.S. Application Data
(63) Continuation of application No. 10/433,170, filed on May 30, 2003.

(30) Foreign Application Priority Data
Dec. 5, 2000 (FR) 0015715

(51) Int. Cl. H01Q 13/10

(52) U.S. Cl. 343/770

(57) ABSTRACT

The present invention relates to a device for the reception and/or the transmission of multibeam signals of the type comprising: a set of several means of receiving and/or transmitting waves with longitudinal radiation of the slot printed antenna type, the said means being disposed so as to receive an azimuthally wide sector, means able to connect in reception one of the said receiving and/or transmitting means to means for utilizing the multibeam signals. This device moreover comprises means able to connect in transmission the set of the said receiving and/or transmitting means to the said means for utilizing the multibeam signals. The invention applies more particularly to the field of wireless transmissions.

This application is a continuation of co-pending U.S. application Ser No. 10/433,170, filed on May 30, 2003.

This application claims the benefit, under 35 U.S. C. § 365 of International Application PCT/EP01/13991, filed Nov. 30, 2001, which was published in accordance with PCT Article 21(2) on Jun. 13, 2002 in English and which claims the benefit of French patent application No. 0015715, filed Dec. 5, 2000.

### BACKGROUND OF THE INVENTION

The present invention relates to a device for the reception and/or the transmission of multibeam signals which are useable more especially in the field of wireless transmissions.

In the known systems for high-throughput wireless transmissions useable in particular in a domestic environrment, the signals sent by the transmitter reach the receiver along a plurality of distinct paths. This results at the level of the receiver in interference liable to cause fadeouts and distortions of the signal transmitted and consequently a loss or a degradation of the information to be transmitted. To remedy this drawback, directional antennas of the horn, reflector or array type are usually used, these antennas being used at the transmitting and/or receiving end and making it possible to combat or attenuate the degradations related to multipaths. Specifically, in addition to the gain afforded by the directional antenna, the latter makes it possible by spatial filtering, on the one hand to reduce the number of multipaths, and hence to reduce the number of fadeouts, and on the other hand to reduce the interference with other systems operating in the same frequency band.

Since directional antennas do not allow for significant azimuthal spatial coverage, French Patent Application No. 98 13855 filed in the name of the applicant has therefore proposed a compact antenna making it possible to increase the spectral efficiency of the array by reusing the frequencies by virtue of a segmentation of the physical space to be covered by the radiation pattern of the sectorial antenna. The antenna proposed in the above patent application consists of a coplanar circular arrangement about a central point of Vivaldi-type printed radiating elements making it possible to present several directional beams sequentially over time, the set of beams giving complete 360° coverage of space.

Whereas this type of antenna makes it possible to obtain good operation of the receiving device, it is often advantageous in transmission to be able to obtain omnidirectional coverage of space, for example when the transmitter system must be able to declare itself to all the users or transmit to several receivers.

### SUMMARY OF THE INVENTION

The aim of the present invention is therefore to propose a device for the reception or the transmission of multibeam signals making it possible to meet this need.

Consequently the subject of the present invention is a device for the transmission and/or the reception of multibeam signals of the type comprising:
a set of several means of receiving and/or transmitting waves with longitudinal radiation of the slot printed antenna type, the said means being disposed so as to receive an azimuthally wide sector,
means able to connect in reception one of the said receiving and/or transmitting means to means for utilizing the multibeam signals,
characterized in that it moreover comprises, means able to connect in transmission the set of the said receiving and/or transmitting means to the said means for utilizing the multibeam signals.

According to one embodiment, the means able to connect in transmission the set of the said receiving and/or transmitting means consist of a microstrip line or a coplanar line crossing the set of slots of the slot printed antennas constituting the receiving and/or transmitting means, the length of the line between two slots being equal, at the central frequency of operation of the system, to kλm/2 and the length of the line between one end of the line and a slot being equal to λm/4 where λm=λ0/√εreff. (with λ0 as wavelength in vacuo and εreff. the effective relative permittivity of the line) and k is an integer. Preferably, the length of the line between two slots is equal to kλm so as to obtain in-phase operation of the printed antennas.

In this case, the crossover between the slot of the slot printed antenna and the line is preferably effected, at the central frequency of operation of the system, at a distance k′λs/4 from the closed end of the slot with λs=λ0/√ε1reff. (λ0 the wavelength in vacuo and ε1reff. the equivalent relative permittivity of the slot) and k′ an odd integer. Preferably, the line is connected by one of its ends to the means for utilizing the multibeam signals.

According to another embodiment, the connection of the line to the means for utilizing the multibeam signals is effected on a line part between two slots at a distance kλm/2 from one of the slots.

According to a further characteristic of the present invention, the means able to connect in reception one of the said receiving and/or transmitting means to the means for utilizing the multibeam signals consist of a portion of microstrip line or of coplanar line, each portion crossing the slot of one of the slot printed antennas and being linked to the means for utilizing the multibeam signals by a switching device. Preferably, the crossover of each portion of line and of the slot of the slot printed antenna is effected, at the central frequency of operation of the system, at a distance k′λs/4 from the closed end of the slot with λs/4=λ0/√ε1reff. (λ0 the wavelength in vacuo and ε1reff. the equivalent relative permittivity of the slot) and k′ an odd integer.

When this embodiment of the means of connection in reception is associated with the embodiment described above of the means of connection in transmission, the distance between transmission lines constituting the means of connection in transmission and the portion of transmission lines constituting the means of connection in reception is equal, at the central frequency of operation of the system, to k″λs/2 with λs=λ0/√ε1reff. (λ0 the wavelength in vacuo and ε1reff. the equivalent relative permittivity of the slot) and k″ an integer.

According to a preferred embodiment, each slot printed antenna is formed by a substrate comprising on a first face at least one excitation microstrip line coupled to a slot line etched on the second face. Preferably, the slot line flares progressively up to the edge of the substrate, the antenna being a Vivaldi-type antenna. The set of antennas constituting the means of receiving and/or transmitting waves with longitudinal radiation is regularly disposed about a single and coplanar point in such a way as to be able to radiate in a 360° angle sector.

### BRIEF DESCRIPTION OF THE DRAWINGS

Other characteristics and advantages of the present invention will become apparent on reading the description of various embodiments, this description being given hereinbelow with reference to the appended drawings in which:

FIG. 1 represents a diagrammatic view of a device according to a first embodiment of the invention,

FIG. 2 represents a diagrammatic view of a line/slot transition making it possible to explain the operation of the device of FIG. 1,

FIG. 3 represents the equivalent electrical diagram of the transition represented in FIG. 2,

FIG. 4 represents the equivalent electrical diagram of the transition represented in FIG. 2 when the lengths have been matched so as to be at resonance,

FIGS. 5, 6 and 7 respectively represent the circuit of a line/slot transition used to simulate the operation of the device of FIG. 1, the level of the signals on various access points as a function of frequency in an omnidirectional mode of excitation and the phase of the signals on the two slot ports in omnidirectional mode of excitation,

FIG. 8 represents a diagrammatic view of a device according to a second embodiment of the invention,

FIG. 9 is a diagrammatic view of a slot/two line transition making it possible to operate the devices of FIGS. 1 and 9 in omnidirectional and sectorial modes,

FIGS. 10 and 11 diagrammatically represent the topology of the circuit of FIG. 9 operating in transmission, and the curves giving the level of the signal as a function of frequency on the various access points in omnidirectional mode,

FIGS. 12 and 13 are representations equivalent to FIGS. 10 and 11 in the case of operation in sectorial mode in reception,

FIGS. 14 and 15 are diagrammatic views of a device according to a third and a fourth embodiment of the present invention, and

FIG. 16 is a plane view of a fifth embodiment of the invention.

To simplify the description, in the figures the same elements bear the same references.

### DESCRIPTION OF PREFERRED EMBODIMENTS

Represented diagrammatically in FIG. 1 is a compact antenna of the type described in French Patent Application No. 98 13855. To receive on an azimuthally wide sector, the means of reception and/or transmission with longitudinal radiation consist of four slot printed antennas 1a, 1b, 1c, 1d regularly spaced around a central point 2. As represented diagrammatically in FIG. 1, the slot antennas comprise a slot-line 1′a, 1′b, 1′c, 1′d flaring progressively from the centre 2 to the end of the structure, in such a way as to constitute a Vivaldi-type antenna. The structure and the performance of the Vivaldi antenna are well known to those skilled in the art and are described in particular in the documents “IEEE Transactions on Antennas and Propagation” by S. Prasad and S. Mahpatra, Volume 2 AP-31 No. 3, May 1983 and “Study of Discontinuities in open waveguide—application to improvement of radiating source model” by A. Louzir, R. Clequin, S. Toutin and P. Gélin, Lest Ura CNRS No. 1329.

As represented in FIG. 1, the four Vivaldi antennas 1a, 1b, 1c, 1d are positioned perpendicularly to one another on a common substrate (not represented). In accordance with the present invention and as represented in FIG. 1, the four antennas 1a, 1b, 1c and 1d are linked together by way of a microstrip line 3, this microstrip line making it possible to produce line/slot transitions and positioned in such a way that the length of line between two slots such as 1′c-1′b, 1′b-1′a or 1′a-1′d is equal, at the central frequency of operation of the system, to k(λ/2), preferably kλm, in which λm=λ0/√εreff. with λ0 the wavelength in vacuo and εreff. the equivalent relative permittivity of the microstrip line. Moreover, to obtain correct operation in omnidirectional mode, the end of the microstrip line 3 is at a distance k′λm/4 from the closest slot 1′d, k′ being an odd integer and λm being given by the above relation. The other end of the microstrip line is connected in transmission to means for transmitting signals of known type, comprising in particular a power amplifier. When the slots of the Vivaldi antennas are fed by a microstrip line exhibiting a length λm or kλm, as represented in FIG. 1, in-phase operation of the antennas is obtained, this giving an optimal radiation pattern, as represented in FIG. 1 by the arrows E representing the radiated electric field.

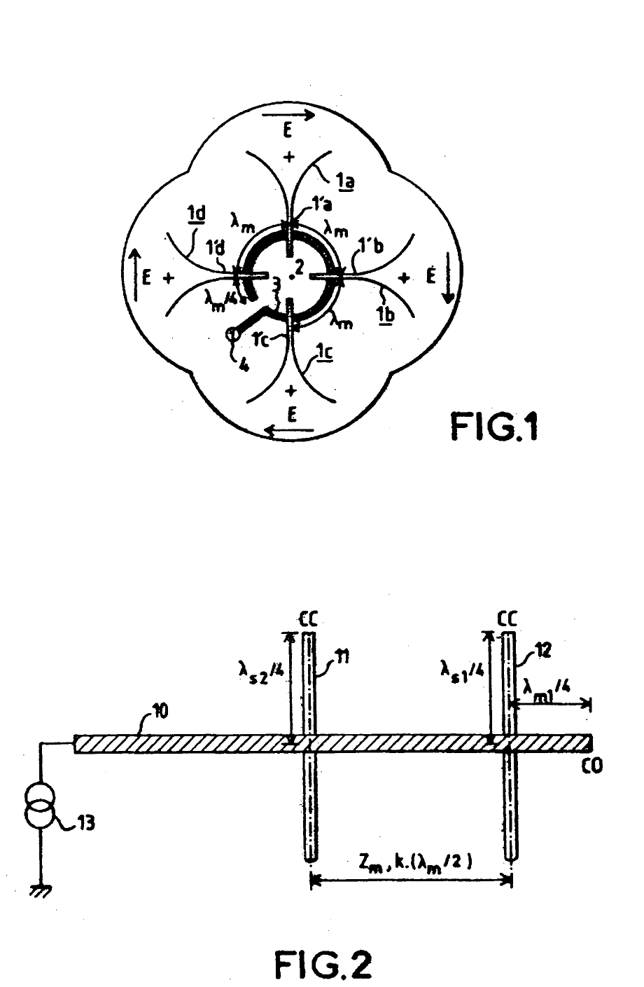

The principle of operation of the device of FIG. 1 will now be explained more particularly with reference to FIGS. 2 to 7.

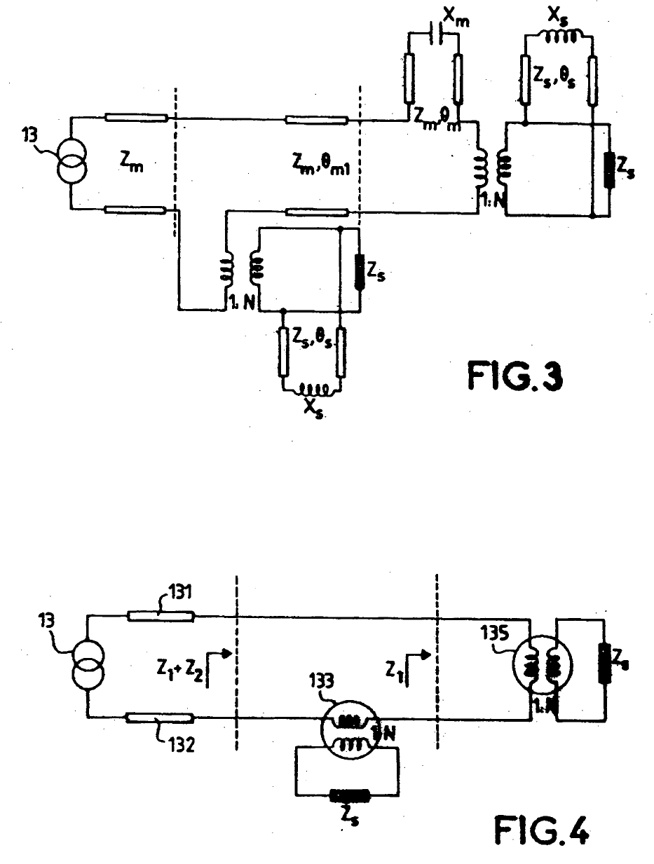

As described hereinabove, the feeding of the Vivaldi antennas relies on the use of a transition between a microstrip line and a slot, more especially on a transition between a microstrip line and several slots in series. Represented in FIG. 2 is the transition of a microstrip line 10 with two slots 11, 12. In the case of FIG. 2, the microstrip line 10 is fed by a generator 13 and the slots 11 and 12 are positioned so that their short-circuited end cc lies at a distance λs2/4 and λs1/4 respectively or more generally an odd multiple of λs2/4 and λs1/4. Moreover, the distance between two successive slots is chosen to be equal to a multiple of half the wavelength, namely kλm/2, so as to lie in one and the same phase plane to within 180°, for each transition. Moreover, as represented in FIG. 2, the slot 12 is positioned at a distance λm/4 or k′λm/4 (k′ odd) from the end of the microstrip line. All the values λs/4, λs2/4, λs1/4 and λm/2 are valid at the central frequency of operation of the system. A line/slot transition exhibits a general equivalent diagram as represented in FIG. 3.

This equivalent diagram is obtained from the equivalent diagram of a simple transition between a microstrip line and a slot line proposed for the first time by B. Knorr. It consists of the impedance Zₛ corresponding to the characteristic impedance of the slot line 11 in parallel with a self-inductive reactance of value Xₛ (corresponding to the end effect of the short circuit terminating the slot line) brought back by a line of characteristic impedance Zₛ and of electrical length θₛ corresponding to the slot line quarter-wave stub (length λₛ₁/4). The assembly is linked to an impedance transformer of transformation ratio N:1. To the other branch of the impedance transformer is linked in series a capacitive reactance Xₘ (corresponding to the end effect of the open circuit terminating the microstrip line) brought back by a line of characteristic impedance Zₘ and of electrical length θₘ corresponding to the microstrip line quarter-wave stub (length λₘ₁/4), with a microstrip line of characteristic impedance Zₘ and of electrical length θₘ₁ corresponding to the microstrip line of length kλₘ/2. This line is linked to another impedance transformer of transformation ratio 1:N linked to the equivalent circuit corresponding to the second slot line quarter-wave stub (length λₛ₂/4) and to the slot line 12. The assembly is linked to a generator 13 situated at the tip of the exciter microstrip line.

In this type of circuit, when it operates near resonance, namely when the microstrip line lengths and the lengths between the microstrip line and the end of the slots are equal to λm/4 and λs/4 respectively, the equivalent circuit of the line is transformed into a short-circuit while the equivalent circuit of the slot Xs is transformed into an open circuit. Therefore, the equivalent circuit becomes a circuit such as that represented in FIG. 4 and in which there now remains only the generator 13, the resistors 131, 132 provided on the two output terminals of the generator 13, a first transformer 133 of ratio 1/N on which the resistor Zs is mounted and a second transformer 135 of ratio 1/N across the output terminals of which is mounted an impedance Zs. It is therefore apparent that the juxtaposition of the slots on a microstrip line is equivalent to a series arrangement of the impedances Z1 and Z2, etc., exhibited by the various transitions. In the case of identical transitions, there is an equal power distribution on each of the excited slots. This mode of operation consequently ensures a feeding of the various Vivaldi antennas in such a way as to obtain omnidirectional radiation.

The principle of operation of a device in accordance with the present invention has been simulated with the aid of a circuit such as represented in FIG. 5. This circuit comprises a microstrip line 10 fed at \textcircled{1}. At a length λm/4 from the end, the line 10 cuts a slot 12 belonging to a Vivaldi-type antenna. This slot can be accessed via the access \textcircled{3}. As described above, the end of the slot 12 lies at a distance λs/4 from the microstrip line. As represented in FIG. 5, at a distance λm/2 from the slot 12 is made another slot 11 constituting an element of a second Vivaldi antenna. This slot can be accessed via the access \textcircled{2}. Moreover, the end of the slot lies at a distance λs/4 from the microstrip line. The ports \textcircled{2} and \textcircled{3} as represented in FIG. 5 make it possible to visualize the energy recovered on the various Vivaldi-type antennas.

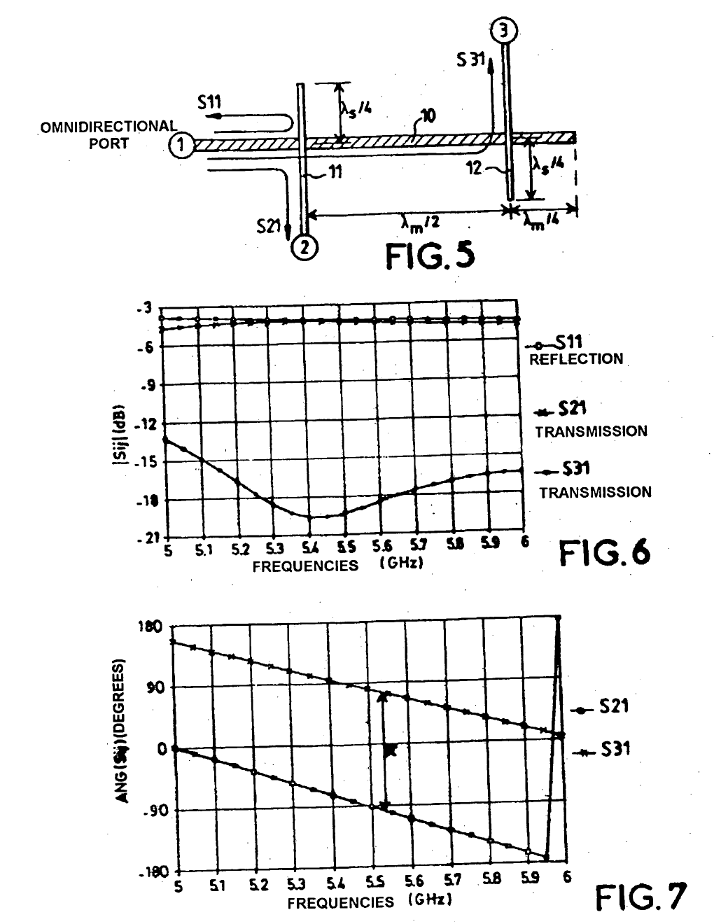

As represented in the curves of FIGS. 6 and 7, it may be seen that the signal transmitted on the microstrip line feed access \textcircled{1} is correctly transmitted to the various slots. Specifically, the coefficient of reflection symbolized by the arrow S11 is less than −16 dB throughout the band lying between 5.2 and 6 GHz. Moreover, the distribution of power to the access ways \textcircled{2} and \textcircled{3} is well balanced since the coefficients of transmission S21 and S31 are substantially the same, as represented in FIG. 6, by the-two top curves. Moreover, represented in FIG. 7 is the phase of the signals recovered on the access ways \textcircled{2} and \textcircled{3}. A phase shift of Π which corresponds to the distance λm/2 separating the two slots 11 and 12 may be observed in the figure.

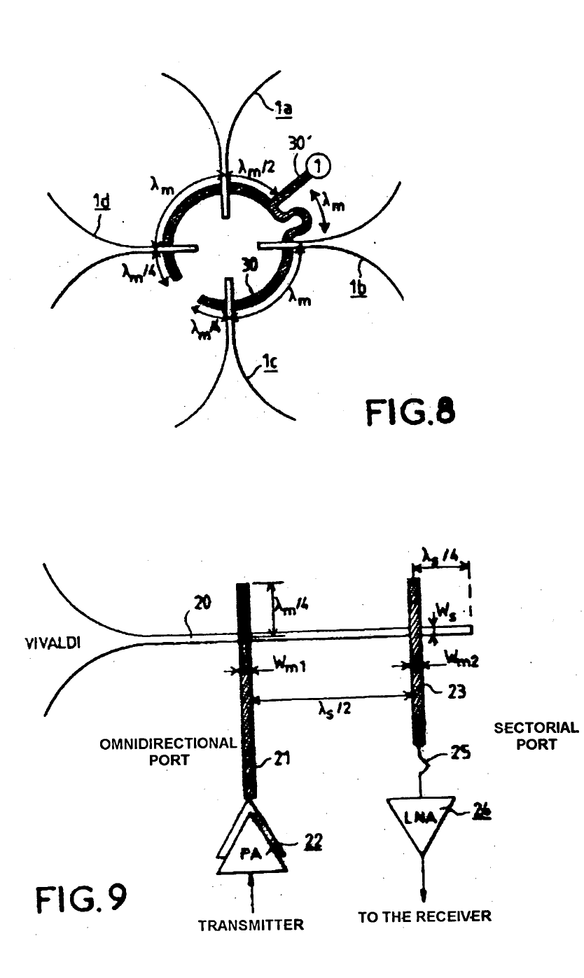

Represented in FIG. 8 is a variant of the device of FIG. 1 in accordance with the present invention. In this case, the microstrip line 30 is not connected by one of these ends to the means for utilizing the signals as in the case of FIG. 1. The microstrip line is connected by a microstrip line segment 30′ provided, for example, between the antenna 1a and the antenna 1b. To allow phase matching of the two Vivaldi-type antennas 1a and 1b, the line part 30′ lies at a distance λm/2 from one of the antennas, namely the antenna 1a and at a distance λm from the other antenna, namely the antenna 1b in the embodiment represented. It is obvious to the person skilled in the art that multiple values of λm/2 and of λm may also be used. In this case, the two ends of the microstrip line 30 crossing the four Vivaldi antennas 1c, 1b, 1a, 1d lie at a distance λm/4, preferably k′λm/4 with k′ odd from the corresponding Vivaldi antenna, namely the antenna 1c and the antenna 1d in the embodiment represented. With a structure such as represented in FIG. 8, operation of the same type as that described in respect of a structure such as that represented in FIG. 1 is obtained.

A further characteristic of the present invention making it possible to connect in reception one of the said Vivaldi-type antennas to the means for utilizing the multibeam signals will now be described with reference more particularly to FIGS. 9 to 15. This characteristic consists of an arrangement as represented in FIG. 9, allowing the simultaneous coupling of two microstrip lines with the slot of a Vivaldi antenna. As represented in FIG. 9, the slot 20 of a Vivaldi-type antenna is crossed by a first microstrip line 21 corresponding to the microstrip line described above and allowing operation in omnidirectional mode. Therefore, the end of the microstrip line 21 is connected to the transmitter circuit 22 by way of a power amplifier Pa. As represented in FIG. 9, the end of the microstrip line 21 lies at a distance λm/4 from the slot 20. Although this is not represented in the drawing, the microstrip line 21 also crosses the slots of the other Vivaldi antennas positioned as, for example, in the embodiment of FIG. 1. Moreover, at a distance λs/2 from the microstrip line 21, another portion of microstrip line 23 cuts the slot 20. As represented in FIG. 9, an end of the portion of the microstrip line 23 is connected by way of a switch 25 such as a diode which, depending on its state, can be off or on, to a receiver circuit 24 comprising a low noise amplifier LNA. As represented in FIG. 9, the end of the slot 20 is positioned at a distance λs/4 from the microstrip line 23. In the above embodiment, the distances λs/4 and λs/2 are, at the central frequency of operation of the system, such that λs=λ0/√εreff. with λ0 the wavelength in vacuo and εreff. the equivalent relative permittivity of the slot while λm=λ0/√εreff. with λ0 the wavelength in vacuo and εreff. the equivalent relative permittivity of the microstrip line. The use of a switching circuit associated with the LNA makes it possible in reception to operate in sectorial mode.

An equivalent electrical diagram of the same type as that represented in FIGS. 3 and 4 can be obtained for the topology of FIG. 9 which in fact corresponds to a double transition between a slot and two microstrip lines. In this case, it is apparent that the juxtaposition of lines on a slot is equivalent to a parallel arrangement of the impedances exhibited by the various transitions.

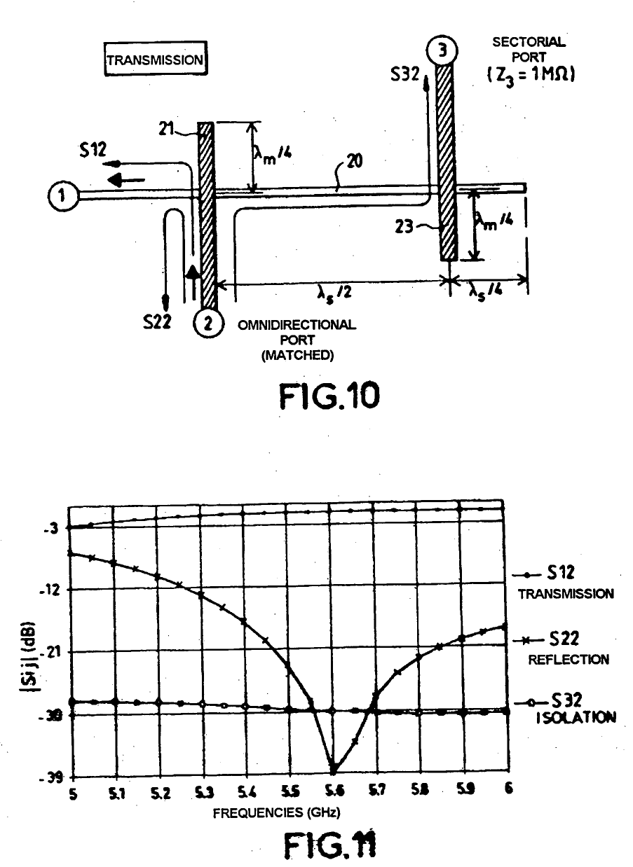

The operation of the circuit of FIG. 9 in transmission and in reception will now be explained more particularly with reference to FIGS. 10, 11, 12 and 13.

Operation in transmission has been simulated on a configuration as represented in FIG. 10. In transmission, the device in accordance with the present invention operates in omnidirectional mode. In this case, the signals are sent to the microstrip line 21 while the line 23 exhibits at the level of its port a high impedance of around 1MΩ. The value of the transmission coefficient S12, reflection coefficient S22 and isolation coefficient S32 are represented in FIG. 11, for a frequency varying between 5 and 6 GHz.

As represented in the curves of FIG. 11, it may be seen that the signal transmitted on the feed access \textcircled{2} of the microstrip line 21 is correctly transmitted to the slot 20. Specifically, the coefficient of reflection symbolized by the arrow S22 remains on the one hand very small since it is less than −10 dB throughout the band lying between 5.2 and 6 GHz. Moreover, the power is distributed well to the access \textcircled{1} since the coefficient of transmission symbolized by S12 is greater than −2 dB over this same band. Finally, no transfer of power occurs to the access \textcircled{3} since the isolation symbolized by S31 is less than −26 dB.

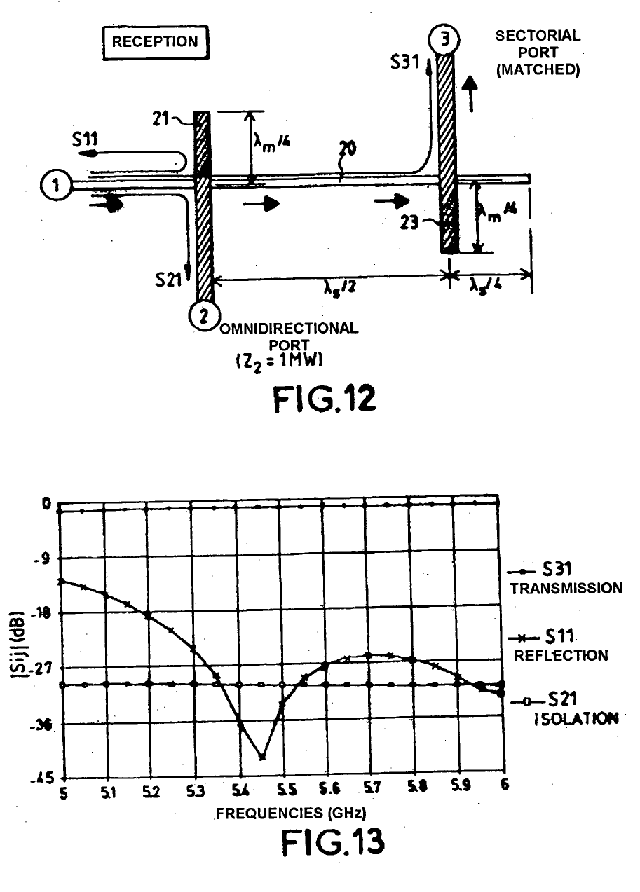

Operation in reception, namely in sectorial mode, will now be described with reference to FIGS. 12 and 13. In this case, the microstrip line 23 is connected to the receiving circuit by closing the switch 25 and the transmission stage brings back a very high impedance, namely an impedance Z2 of around 1MΩ on the access to the microstrip line 21. With this type of circuit, one obtains a transmission coefficient S31, reflection coefficient S11 and isolation coefficient S21 as represented in FIG. 13, for a frequency value varying between 5 and 6 GHz.

As represented in the curves of FIG. 12, it may be seen that the signal received on the access \textcircled{1} of the slot 20 is transmitted correctly to the microstrip line 23 corresponding to the reception access. Specifically, the coefficient of reflection symbolized by the arrow S11 remains on the one hand very small since it is less than −10 dB throughout the band lying between 5.2 and 6 GHz. Moreover, the power is distributed well to the access \textcircled{3} since the transmission coefficient symbolized by S31 is greater than −2 dB over this same band. Finally, no transfer of power occurs to the access \textcircled{3} since the isolation symbolized by S21 is less than −29 dB.

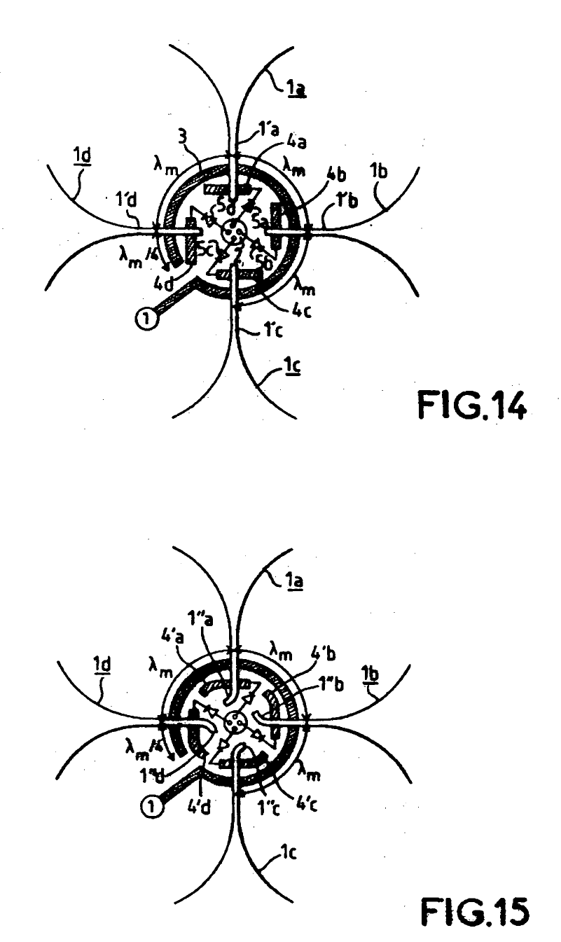

Represented diagrammatically in. FIGS. 14 and 15 are two embodiments of a transmission/reception device in accordance with the invention. Just as for FIG. 1, the reception/transmission means consist of four slot printed antennas 1a, 1b, 1c, 1d, regularly spaced around a central point. The printed antennas are, just as in FIG. 1, of Vivaldi type. The four Vivaldi, antennas are positioned perpendicularly to one another. The slots. 1′a, 1′b, 1′c, 1′d of the four antennas are linked together by a microstrip line 3 placed as in the embodiment of FIG. 1, in such a way as to allow in transmission operation in omnidirectional mode. Moreover, each slot 1′a, 1′b, 1′c, 1′d is crossed by a portion of microstrip line 4a, 4b, 4c, 4d linked by a switch 5a, 5b, 5c, 5d to the reception circuit, so as to obtain operation in sectorial mode, as explained above. The dimensions and positions of the microstrip lines 3, 4a, 4b, 4c and 4d correspond to what was explained above.

The embodiment of FIG. 15 is substantially identical to that of FIG. 14. Simply for reasons of bulkiness, the ends of the slots 1″a, 1″b, 1″c, 1″d have been curved inwards as have the portions of microstrip lines 4′a, 4′b, 4′c, 4′d.

According to an other embodiment of a device of the same type as that represented in FIGS. 14 and 15, represented in FIG. 16, the feed line corresponding to the microstrip line consists of a coplanar line exhibiting two slots I1, I2 and a metallization m. In this case, the slot lines 1a, 1b, 1c, 1d forming the Vivaldis are separated by metallizations m. Likewise, the line portions consist of coplanar line portions 4″a, 4″b, 4″c, 4″d connected by switches 5a, 5b, 5c, 5d as in theembodiment of FIGS. 14 and 15. It is obvious to the person skilled in the art that any mixture of the above structures may be envisaged, such as:
Omnidirectional mode: microstrip line/sectorial mode: microstrip line.
Omnidirectional mode: coplanar line/sectorial mode: microstrip line.
Omnidirectional mode: microstrip line/sectorial mode: coplanar line.
Omnidirectional mode: coplanar line/sectorial mode: coplanar line.

It is obvious to the person skilled in the art that the embodiments described above may be modified, in particular as regards the number of Vivaldi antennas, the type of feed of the structure or the type of switch, etc., without departing from the scope of the claims below.

1- Device for the reception and/or transmission of multibeam signals of the type comprising on a same substrate
several slot printed antennas, the slot antennas being disposed so as to receive an azimuthally wide sector, and
a common feed line crossing the set of all slot antennas and able to connect all slot antennas to a means for transmitting signals, said common feed line consisting of line in printed technology.

2- Device according to claim 1, wherein the common feed line in printed technology consists of a microstrip line or a coplanar line, the length of the line between two slots being equal, at the central frequency of operation of the system, to kλm/2 and the length of line between one end of the line and a slot being equal to λm/4 where λm=λ0/√εreff. with λ0 the wavelength in vacuo and εreff. the equivalent relative permittivity of the feed line and k is an integer.

3- Device according to claim 2, wherein the crossover between the slot of the slot printed antenna and the common feed line is effected, at the central frequency of operation of the system, at a distance k′λs/4 from a closed end of the slot with λs=λ0/√ε1reff. (λ0 the wavelength in vacuo and ε1reff. the equivalent relative permittivity of the slot) and k′ is an odd integer.

4- Device according to claim 2, wherein one end of the common feed line is connected to the means for utilizing the multibeam signals.

5- Device according to claim 2, wherein the connection of the common feed line to the means for utilizing the multibeam signals is effected on a feed line part between two slots at a distance kλm/2 from one of the slots.

6- Device according to claim 5, wherein the crossover of each portion of line and of the slot of the slot printed antenna is effected, at the central frequency of operation of the system, at a distance k′λs/4 from a closed end of the slot with λs=0/√ε1reff. (λ0 the wavelength in vacuo and ε1reff. the equivalent relative permittivity of the slot) and k′ is an odd integer.

7- Device according to claim 1, wherein each slot of the slot antennas is formed on a first face of the substrate, the feed line being made on the second face in order to cross the said slot.

8- Device according to claim 7, wherein the slot flares progressively up to the edge of the substrate.

9- Device according to claim 8, wherein the antenna is of the Vivaldi antenna type.

10- Device according to claim 7, wherein the slots are regularly disposed about a single and coplanar point, in such a way as to be able to radiate in a 360° angle sector.
